(19) United States
(12) Patent Application Publication
(10) Pub. No.: US 2012/0107677 A1
(43) Pub. Date: May 3, 2012

(54) ENERGY STORAGE DEVICE FLUID APERATURE

(75) Inventors: Afsar M. Ali, Maple Grove, MN (US); David P. Guy, Maple Grove, MN (US); Jason T. Papenfuss, Minneapolis, MN (US); Pankaj Mohan, Maple Grove, MN (US)

(73) Assignee: MEDTRONIC, INC., Minneapolis, MN (US)

(21) Appl. No.: 12/914,766

(22) Filed: Oct. 28, 2010

(51) Int. Cl. H01M 2/02; B23K 26/20; B23K 26/36

(52) U.S. Cl. 429/185; 29/623.2; 219/121.69; 219/121.66

(57) ABSTRACT

An energy storage device may include a housing and a fluid access aperture extending through a sidewall of housing that is used to fill the device with electrolytic fluid. In some examples, the fluid access aperture may define a length extending through the housing that is greater than a major width that extends across a cross-sectional area of the fluid access aperture. In some additional examples, the fluid access aperture may be angled relative to an axis that is substantially orthogonal to the housing. Depending on the situation, such example fluid access apertures may prevent electrolytic fluid from escaping from the energy storage device while the fluid access aperture is being sealed.

### TECHNICAL FIELD

This disclosure relates to energy storage devices and, more particularly, to fluid apertures for energy storage devices.

### BACKGROUND

A variety of medical devices are used to monitor and/or treat patients suffering from different medical conditions. Example medical devices include pacemakers, cardioverter-defibrillators, drug pumps, neurostimulators, and physiological monitors. In some examples, these devices are intended to provide a patient with a therapeutic output to alleviate or assist with the medical condition the patient is experiencing. In some examples, these devices are intended to monitor a condition of the patient to help diagnose or track the medical condition the patient is experiencing. Typically, such devices are implanted in a patient, although the devices may be external to the patient as well.

Many medical devices include energy storage devices that function to power the various components of the devices and/or power the circuitry of the devices that delivers a therapeutic output. For example, an implantable medical device typically includes one or more batteries that provide operating power to the device over the service life of the device. As another example, some medical devices include capacitors that are used to generate stimulation signals, e.g., pulses, during therapy delivery.

Energy storage devices for medical devices can be constructed from a variety of different materials using a variety of different techniques. In some examples, an energy storage device includes an anode and a cathode separated by a separator material. Typically, such energy storage devices include one or more fluid access apertures (i.e., fill ports) that allow liquid electrolyte to be added to the device during fabrication. After filling the energy storage device with electrolytic fluid, the fluid access aperture is sealed closed to prevent the electrolytic fluid from exiting the device during subsequent use.

In some instances, electrolytic fluid may escape from an energy storage device while a fluid access aperture is being sealed closed. While such escape may not affect some energy storage devices, in other examples, escaping electrolytic fluid may prevent a fluid access aperture from being properly sealed. In these examples, the energy storage device may require further processing in order to fully seal the fluid access aperture closed.

### SUMMARY

In general, the disclosure describes fluid access apertures for energy storage devices. In some examples, an energy storage device may include a high aspect ratio fluid access aperture, where the aspect ratio of the aperture is determined by dividing the length of the aperture by the maximum width of the aperture. For example, an energy storage device may include an aspect ratio greater than 1, such as, e.g., an aspect ratio greater than approximately 2 or more. In instances where an energy storage device includes a fluid access aperture that defines a length greater than a width, the possibility that electrolytic fluid may escape out of the energy storage device while the fluid access aperture is being sealed may be reduced or eliminated as compared to fluid access apertures with different types of configurations.

In some additional examples in accordance with the disclosure, an energy storage device may include a fluid access aperture that is angled relative to an axis that is substantially orthogonal to the energy storage device. For example, an energy storage device may include a fluid access aperture that is created at an angle relative to an axis normal to a surface of the energy storage device. Electrolytic fluid escape may be reduced or eliminated when sealing a fluid access aperture on such an example energy storage device as compared to an energy storage device that does not include an angled fluid access aperture. Moreover, in instances where a fluid access aperture on such an example energy storage device is sealed with a laser beam, the angled fluid access aperture may prevent the laser beam from contacting electrolytic fluid and/or components housed in the energy storage device. This may reduce the likelihood that electrolytic fluid may evaporate, or that components may be damaged from incidental laser energy as compared to an energy storage device that does not include an angled fluid access aperture.

In one example according to the disclosure, an energy storage device includes a housing that includes at least one sidewall, the housing defining a chamber for storing electrolytic fluid. According to the example, the at least one sidewall defines an aperture formed through the at least one sidewall, the aperture defining a major width (W) that extends across a cross-sectional area of the aperture, and the aperture defining a length (L) that extends through the at least one sidewall. The example also specifies that the length of the aperture is greater than the major width of the aperture.

In another example, a method is described that includes creating an aperture in a sidewall of a housing that defines a chamber for storing electrolytic fluid, where creating the aperture comprises creating the aperture such that a length of the aperture that extends through the sidewall is greater than a major width of the aperture that extends across a cross-sectional area of the aperture.

In another example, an energy storage device includes a housing that includes at least one sidewall, the housing defining a chamber for storing electrolytic fluid. According to the example, the at least one sidewall defines an aperture formed through the at least one sidewall, and the aperture is angled relative to an axis that is substantially orthogonal to the at least one sidewall.

In another example, a method is described that includes creating an aperture in a sidewall of a housing that defines a chamber for storing electrolytic fluid, where creating an aperture comprises creating the aperture such that the aperture is angled relative to an axis that is substantially orthogonal to the sidewall.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a conceptual diagram illustrating an example implantable cardiac device (ICD).

FIG. 2 is a conceptual diagram of an example energy source that may be included in the example implantable cardiac device of FIG. 1.

FIGS. 3A and 3B are schematic illustrations of an example fluid filling aperture that may be included on the example energy source of FIG. 2.

FIGS. 4A and 4B are conceptual drawings of an example process for sealing the example fluid filling aperture of FIGS. 3A and 3B.

FIGS. 5A and 5B are schematic illustrations of another example fluid filling aperture that may be included on the example energy source of FIG. 2.

FIG. 6 is a flow diagram illustrating an example technique for creating and sealing a fluid filling aperture.

FIGS. 7A and 7B are images of an example fluid filling aperture taken before and after sealing, respectively, that is in accordance with the disclosure.

FIGS. 8A and 8B are images of another example fluid filling aperture taken before and after sealing, respectively, that is in accordance with the disclosure.

### DETAILED DESCRIPTION

An implantable medical device may be implanted in the body of a patient to monitor the condition of the patient (e.g., monitor physiological characteristics of the patient) and/or to deliver a therapeutic output to alleviate or assist with the medical condition the patient is experiencing. The implantable medical device may include one or more energy storage devices that function to power the different features of the medical device. For example, the implantable medical device may include one or more batteries that provide operating power to the medical device and that power the various electrical features of the medical device. As another example, the medical device may include one or more capacitors that are used to generate electrical stimulation therapy.

Depending on the specific configuration of the energy storage device for the implantable medical device, the energy storage device may include a housing that stores electrolytic fluid. The electrolytic fluid may allow ions to transfer back and forth between an anode and a cathode while the energy storage device is charging and/or discharging. In this manner, the electrolytic fluid may support different energy storage and energy discharge functions of the energy storage device.

During the fabrication of such an example energy storage device, liquid electrolytic fluid may be added to the energy storage device through one or more fluid access apertures that are created in the housing of the energy storage device. After adding a suitable amount of electrolytic fluid to the energy storage device, the one or more fluid access apertures may be sealed closed to hermetically seal the housing of the energy storage device for the service life of the energy storage device. For example, a portion of the housing adjacent the one or more fluid access apertures may be melted such that the melted material flows into the one or more fluid access apertures. This melted material may seal the one or more fluid access apertures closed after cooling and solidifying.

In some instances, while sealing the one or more fluid access apertures, electrolytic fluid may escape from the energy storage device and onto the housing of the energy storage device. For example, when using a laser to seal the one or more fluid access apertures, laser energy applied to the housing of the energy storage device may cause a portion of electrolytic fluid within in the housing to evaporate out of the housing through the one or more fluid access apertures. Electrolytic fluid that escapes from the housing of the energy storage device may mix with material that is being melted from the housing to seal the one or more fluid access apertures. This mixing may comprise the material properties (e.g., reduce the mechanical strength) of the material that seals the one or more fluid access apertures as compared to when melted material from the housing of the energy storage does not mix with electrolytic fluid.

In accordance with some examples described in this disclosure, however, an energy storage device includes a fluid access aperture that may prevent electrolytic fluid from escaping out of the energy storage device while the fluid access apertures is being sealed. In some examples, an energy storage device may include a fluid access aperture that defines a length extending through a housing of the energy storage device that is greater than a major width that extends across a cross-sectional area of fluid access aperture. In some additional examples in accordance with the disclosure, an energy storage device may include a fluid access aperture that is angled relative to an axis that is substantially orthogonal to a housing of the energy storage device. Such example energy storage devices may, in some examples, prevent electrolytic fluid from escaping out of the energy storage devices while the fluid access apertures of the devices are being sealed.

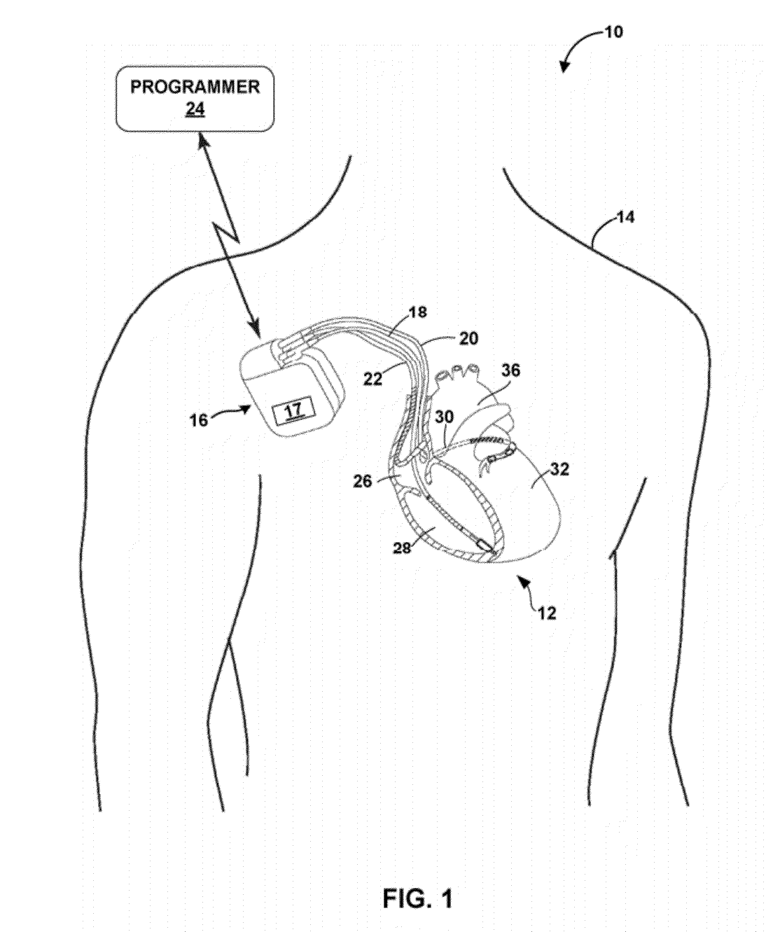

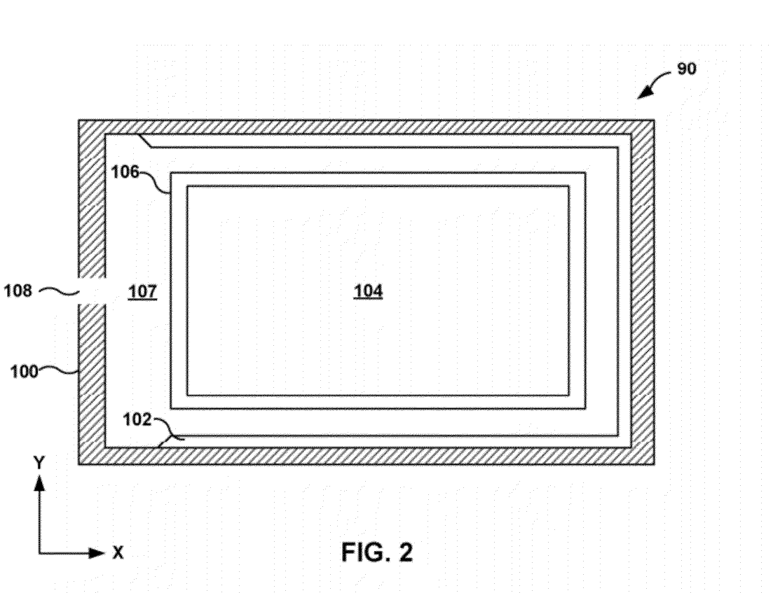

Example energy storage device fluid access apertures will be described in greater detail with reference to FIGS. 2-8. However, an example system with an implantable medical device that includes an energy storage device will first be described with reference to FIG. 1.

FIG. 1 is a conceptual diagram illustrating an example system 10 that monitors and/or provides therapy to a heart 12 of a patient 14. System 10 includes implantable medical device (IMD) 16, which is coupled to implantable leads 18, 20 and 22. Thus, system 10 may be referred to as an implantable medical device system. IMD 16 may be, for example, an implantable pacemaker, cardioverter, and/or defibrillator that senses electrical activity within heart 16 and provides electrical signals to heart 12 via electrodes coupled to leads 18, 20, and 22.

Leads 18, 20, 22 extend into the heart 12 of patient 14 to sense electrical activity of heart 12 and/or deliver electrical stimulation to heart 12. In the example shown in FIG. 1, right ventricular (RV) lead 18 extends through one or more veins (not shown), the superior vena cava (not shown), and right atrium 26, and into right ventricle 28. Left ventricular (LV) coronary sinus lead 20 extends through one or more veins, the vena cava, right atrium 26, and into the coronary sinus 30 to a region adjacent to the free wall of left ventricle 32 of heart 12. Right atrial (RA) lead 22 extends through one or more veins and the vena cava, and into right atrium 26 of heart 12. As shown in FIG. 1, IMD 16 is coupled to three leads, e.g. leads 18, 20, and 22. However, in other examples, IMD 16 may be coupled to more or fewer leads.

IMD 16 may sense electrical signals attendant to the depolarization and repolarization of heart 12 via electrodes (not shown in FIG. 1) coupled to at least one of the leads 18, 20, 22. In some examples, IMD 16 provides pacing pulses to heart 12 based on the electrical signals sensed within heart 12. The configurations of electrodes used by IMD 16 for sensing and pacing may be unipolar or bipolar. In some examples, IMD 16 provides pacing pulses as part of a cardiac resynchronization therapy (CRT) or anti-tachycardia pacing therapy (ATP).

IMD 16 may also provide defibrillation therapy and/or cardioversion therapy via electrodes located on at least one of the leads 18, 20, 22. IMD 16 may detect arrhythmia of heart 12, such as fibrillation of ventricles 28 and 32, and deliver ATP, or cardioversion or defibrillation therapy, to heart 12 in the form of electrical pulses. In some examples, IMD 16 may be programmed to deliver a progression of therapies, e.g., ATP followed by defibrillation, or pulses with increasing energy levels, until a tachyarrhythmia of heart 12 is stopped. IMD 16 detects tachycardia or fibrillation employing one or more tachycardia or fibrillation detection techniques known in the art.

IMD 16 includes at least one energy storage device 17 that houses an electrolytic fluid. Energy storage device 17 may function to power the various components of IMD 16 and/or power the circuitry of IMD 16 that delivers a therapeutic output. In one example, energy storage device 17 may be a battery. In another example, energy storage device 17 may be a capacitor. IMD 16 may also include a combination of batteries and capacitors. As will be described in greater detail below, the at least one energy storage device 17 may be filled with electrolytic fluid through a fluid access aperture during the fabrication of the energy storage device. Further, the fluid access aperture may be sealed to hermetically seal the electrolytic fluid in the energy storage device for the service life of energy storage device 17.

In the example of FIG. 1, system 10 also includes a programmer 24. Programmer 24 is a computing device that may be used to communicate with IMD 16. For example, a user may interact with programmer 24 to retrieve physiological or diagnostic information from IMD 16. A user may also interact with programmer 24 to program IMD 16, e.g., select values for operational parameters of IMD 16.

For example, the user may use programmer 24 to retrieve information from IMD 16 regarding the rhythm of heart 12, trends therein over time, or arrhythmic episodes. As another example, the user may use programmer 24 to retrieve information from IMD 16 regarding other sensed physiological parameters of patient 14, such as intracardiac or intravascular pressure, activity, posture, respiration, or thoracic impedance. As another example, the user may use programmer 24 to retrieve information from IMD 16 regarding the performance or integrity of IMD 16 or other components of system 10, such as leads 18, 20 and 22, or an energy source of IMD 16.

IMD 16 is one example of a medical device that may use an energy storage device in accordance with the present disclosure. Although described in the context of an implantable medical device system including an implantable cardiac device, the techniques described herein may be applicable to other implantable medical device systems including other implantable medical devices that include one or more energy sources. For example, the techniques described herein may be applicable to implantable medical device systems comprising other implantable medical devices that include an energy source, such as spinal cord stimulators, deep brain stimulators, or other implantable neurostimulators, as well as implantable pumps. Furthermore, in some examples, the techniques of the disclosure may be applied to medical devices that are not implanted, or even energy storage devices that are not used with a medical device.

FIG. 2 is a conceptual diagram of an example energy source 17 that may be included in the example IMD 16 of FIG. 1. In particular, FIG. 2 illustrates an example capacitor 90 that may be used in the example IMD 16 of FIG. 1 to generate pulses during therapy delivery. As such, the remainder of the present disclosure generally refers to an example energy storage device as a capacitor. However, the fluid access aperture techniques of the present disclosure may be applied to other types of energy storage devices, or capacitors with configurations other than the configuration of capacitor 90 described below, and it should be appreciated that the disclosure is not limited to any particular type of energy storage device.

In the example of FIG. 2, which depicts one example energy storage device, capacitor 90 includes housing 100, cathode 102, anode 104, separator 106, electrolyte chamber 107, and fluid access aperture 108. Cathode 102, anode 104, and separator 106 are disposed within housing 100, while electrolyte chamber 107 is defined as the free space within housing 100 that is not occupied by cathode 102, anode 104, separator 106, or other components of capacitor 90. Liquid electrolyte (not shown) may be introduced into electrolyte chamber 107 through fluid access aperture 108, and fluid access aperture 108 may thereafter be sealed to provide a hermetically sealed housing 100.

As will be described in greater detail below, fluid access aperture 108 may be configured to prevent electrolytic fluid from escaping out of electrolytic chamber 107 and, hence, housing 100, while sealing fluid access aperture 108. For instance, in one example, fluid access aperture 108 may define a length extending through housing 100 that is greater than a major width that extends across a cross-sectional area of fluid access aperture 108. In another example, fluid access aperture 108 may be angled relative to an axis that is substantially orthogonal to housing 100. Such example fluid access apertures may, in some examples, prevent electrolytic fluid from escapinging out of electrolytic chamber 107 while fluid access aperture 108 is being sealed. When electrolytic fluid escapes out of electrolytic chamber 107, the fluid may interfere with a seal that is subsequently provided over fluid access aperture 108. For example, the escaped fluid may mix with a sealing material that is added to fluid access aperture 108, which may, e.g., prevent the sealing material from hermetically sealing housing 100 or compromise the material properties of the seal so formed over fluid access aperture 108.

In operation, capacitor 90 is capable of storing a high voltage charge and releasing the charge during therapy delivery. Capacitor 90 may be electrically connected to a battery in IMD 16 (FIG. 1) and charged to create a potential difference between cathode 102 and anode 104. A rapid electrochemical reaction between cathode 102 and anode 104 may thereafter release high voltage energy during therapy delivery.

Capacitor 90 includes housing 100 that, in some examples, is constructed of a material that resists corrosion and degradation from electrolytic fluids including, e.g., aluminum, titanium, stainless steel, tantalum, niobium, a ceramic material, or the like. Housing 100 encases the different components of capacitor 90. Accordingly, housing 100 may be size and shaped, e.g., based on the size and arrangement of the components of capacitor 90. Housing 100 may define a variety of shapes including a cylinder, a sphere, or a D-shape, although in the example of FIG. 2, housing 100 includes four sidewalls that define a substantially rectangular shape. In some examples, housing 100 may define a cavity between approximately 0.5 cubic centimeters and approximately 1.0 cubic centimeters that houses the various components of capacitor 90, although other sizes are both contemplated and possible.

Cathode 102 is positioned within housing 100 and separated from anode 104 by separator 106. Cathode 102 may be formed from a variety of electrically conductive materials including, e.g., a carbon-containing cathode material deposited on a substrate. Example substrates include, but are not limited to, tantalum, nickel, platinum, palladium, gold, silver, cobalt, copper, chromium, vanadium, aluminum, zirconium, hafnium, zinc, iron, and combinations thereof. In some examples, cathode 102 may include carbon-containing cathode material deposited on an interior surface of housing 100. In other examples, cathode 102 may be electrically isolated from an interior surface of housing 100. Cathode 102 may be electrically connected outside of housing 100 via a cathode connector (not shown in FIG. 2) that extends from cathode 102 through a sidewall of housing 100. In some examples, the cathode connector may be electrically isolated from housing 100 by an insulating feed-through (not shown in FIG. 2) that seals the cathode connector to housing 100.

Capacitor 90 also includes anode 104 that is positioned within housing 100. In some examples, anode 104 may be constructed from a valve metal including, e.g., tantalum, aluminum, titanium, niobium, zirconium, hafnium, tungsten, molybdenum, or vanadium. Similar to cathode 102, anode 104 may be electrically connected outside of housing 100 via an anode connector (not shown in FIG. 2) that extends from anode 104 through a sidewall of housing 100. In some examples, the anode connector may be electrically isolated from housing 100 by an insulating feed-through (not shown in FIG. 2) that seals the anode connector to housing 100.

In the example of FIG. 2, anode 104 and cathode 102 are separated by separator 106. Separator 106 may function to prevent physical contact between anode 104 and cathode 102 while allowing free ionic transport through separator 106. In this regard, separator 106 may, in some examples, be fabricated from a porous material such as, e.g., a micro-porous polymer of Kraft paper.

During the fabrication of capacitor 90, a liquid electrolyte may be introduced into electrolyte chamber 107 through fluid access aperture 108. The electrolyte may provide a medium for transferring ions between anode 104 and cathode 102 which, in turn, may help create a voltage difference across anode 104 and cathode 102. The selection of a particular electrolyte may depend, e.g., on the reactivity of the electrolyte with the materials used for anode 104 and cathode 102. That being said, in some examples, an electrolyte for capacitor 90 may include sulfuric acid, dissolved ammonium salts (e.g., ammonium acetate), mixtures of water, glycol, and ether, phosphoric acid, or the like. Other electrolytes are possible.

While constructing capacitor 90, the various components of capacitor 90 may be positioned and/or affixed within housing 100. Housing 100 may thereafter be sealed to encase the components of capacitor 90. To subsequently fill electrolytic chamber 107 with electrolytic fluid, housing 100 may include one or more fluid access apertures that extend through a sidewall of housing 100. For example, as shown in FIG. 2, capacitor 90 includes fluid access aperture 108 that extends through a sidewall of housing 100.

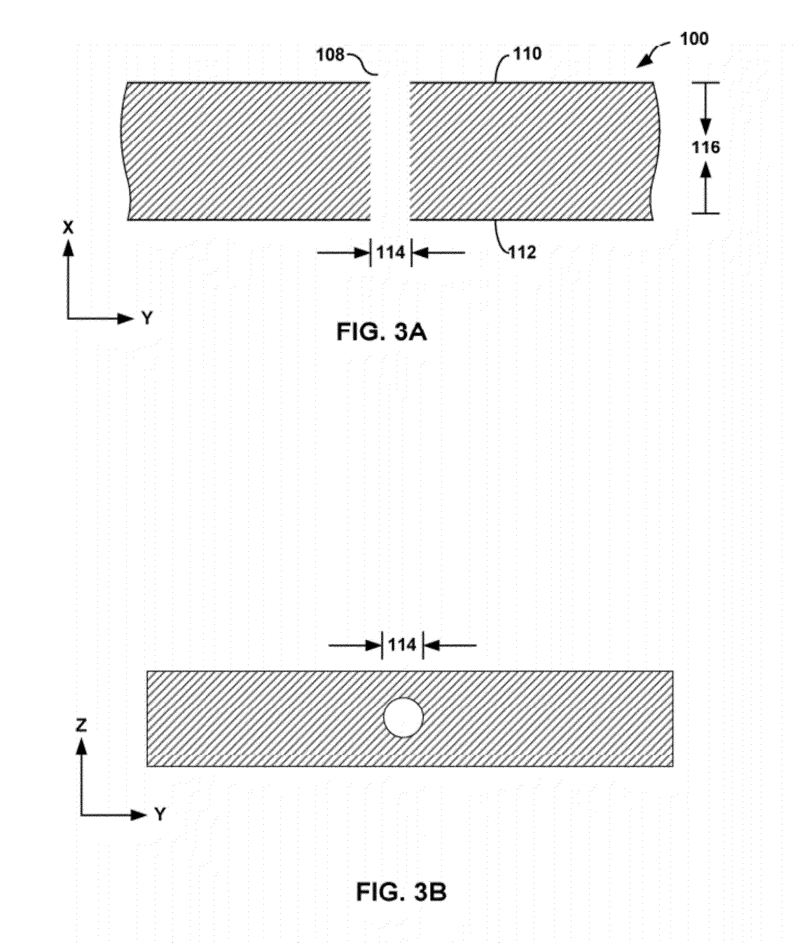

Fluid access aperture 108 is an opening defined in a sidewall of housing 100 that may be used to add electrolytic fluid from outside of housing 100 to electrolytic chamber 107. FIGS. 3A and 3B are different exploded schematic views of one example of fluid access aperture 108. As seen in FIGS. 3A and 3B, fluid access aperture 108 defines a substantially circular opening that extends from a first surface 110 to a second surface 112. First surface 110 may be an external surface of housing 100, while second surface 112 may be an internal surface of housing 100 that is in fluid contact with electrolytic fluid within electrolyte chamber 107.

Fluid access aperture 108 may be formed in housing 100 using a variety of different techniques. In some examples, housing 100 may be cast or molded to include fluid access aperture 108. In other examples, housing 100 may be machined to include fluid access aperture 108. A machining process may involve cutting, punching, or drilling housing 100 to define fluid access aperture 108. For instance, in one example, a laser drill may be used to drill fluid access aperture 108 into housing 100. The specific operating parameters for the laser drill may vary, e.g., based on the intended size of fluid access aperture 108 and the types of material used to fabricate housing 100. However, in some examples, the laser may emit optical pulses with a duration between approximately 0.1 nanoseconds and 10 picoseconds, and the laser drill may define a spot size generally corresponding to the cross-sectional size of fluid access aperture 108. Other techniques can be used to create a fluid access aperture, and it should be appreciated that a fluid access aperture in accordance with the present disclosure are not limited in this respect.

Fluid access aperture 108 can define a variety of different cross-sectional shapes in the X-Y plane illustrated on FIG. 3A. In some examples, fluid access aperture 108 may taper (e.g., decrease in diameter) from first surface 110 to second surface 112 in the X-Y plane. In other examples, fluid access aperture 108 may widen (e.g., increase in diameter) from first surface 110 to second surface 112 in the X-Y plane. Therefore, although fluid access aperture 108 in the example of FIG. 3A defines a rectangular shape in the X-Y plane, alternative shapes may be used for fluid access aperture 108.

Fluid access aperture 108 can also define a variety of different cross-sectional shapes in the Y-Z plane illustrated on FIG. 3B. In some examples, fluid access aperture 108 may define a polygonal shape (e.g., triangle, square, hexagon) in the Y-Z plane. In other examples, as shown in FIG. 3B, fluid access aperture 108 may define an arcuate shape (e.g., ellipse, circle) in the Y-Z plane. Combinations of arcuate and polygonal shapes are also contemplated. In general, fluid access aperture 108 may define any suitable shape that allows electrolytic fluid to be added to electrolytic chamber 107.

Fluid access aperture 108 defines a major width 114 and a length 116. Major width 114 is the largest dimension that extends across a cross-sectional area of fluid access aperture in the Y-X plane illustrated on FIG. 3B. For example, with respect to the example of FIG. 3B, major width 114 is the diameters of fluid access aperture 108. Fluid access aperture 108 also defines length 116. Length 116 is a measure of the distance between first surface 110 and second surface 112 along a centerline of fluid access aperture 108. In the example of FIG. 3A, where fluid access aperture 108 extends orthogonally through housing 100, length 116 is established by the thickness of the material used to fabricate housing 100.

In accordance with some examples of the present disclosure, as described in greater detail below, fluid access aperture 108 may be designed such that length 116 of fluid access aperture 108 is greater than major width 114 of fluid access aperture 108. In other words, fluid access aperture 108 may be designed such that a ratio of length 116 to major width 114 of fluid access aperture 108 is greater than 1. Such an example fluid access aperture may be sealed more effectively during the fabrication of capacitor 90 than fluid access apertures with other types of configurations.

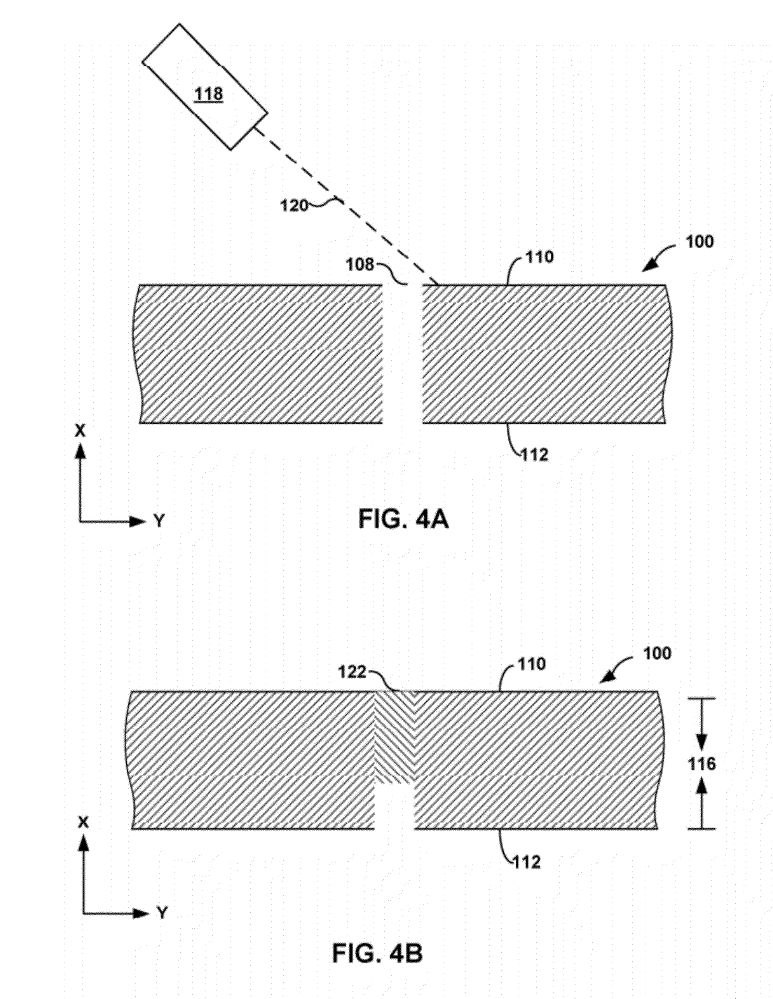

In general, any suitable technique can be used to seal fluid access aperture 108 after filling electrolytic chamber 107 with electrolytic fluid. In some examples, a sealing material such as, e.g., solder, weld flux, a polymeric bonding agent, an epoxy, or the like may be added to fluid access aperture 108 to hermetically seal fluid access aperture 108. In other examples, a laser may be used to melt a portion of housing 100 adjacent fluid access aperture 108 such that melted material flows into fluid access aperture 108 to seal fluid access aperture 108. FIGS. 4A and 4B are schematic illustrations of one example process that may be used to seal fluid access aperture 108 using such a laser process.

As seen in FIG. 4A, laser 118 directs laser beam 120 on a portion of housing 100 adjacent fluid access aperture 108. In some examples, laser beam 120 may be directed on a single portion of housing 100 adjacent fluid access aperture 108. In other examples, laser beam 120 may be directed on multiple portions of housing 100 adjacent fluid access aperture 108. For example, laser beam 120 may be traversed around a perimeter of fluid access aperture 108 on housing 100.

During operation, laser 118 may operate at a power sufficient to melt a portion of housing 100 adjacent fluid access aperture 108. The specific operating parameters of laser 118 may vary, e.g., based on the thickness and material composition of housing 100. However, in some examples, laser 118 may emit optical pulses with a duration between approximately 0.1 milliseconds and 10 milliseconds. In some examples, laser 118 may operate at a peak power between approximately 500 Watts and approximately 1500 Watts. In some additional examples, laser 118 may operate to define a laser beam spot size between approximately 0.004 inches and approximately 0.026 inches. The foregoing laser operating parameters are merely examples, however, and laser 118 may operate at any parameters sufficient to melt a portion of housing 100 adjacent fluid access aperture 108.

Independent of the specific operating parameters of laser 118, laser 118 may melt a portion of housing 100 adjacent fluid access aperture 108 to a flowable state to fill the aperture. FIG. 4B is a conceptual drawing of one example of fluid access aperture 108 filled with material 122 melted from a sidewall of housing 100. As seen in FIG. 4B, material 122 may flow into fluid access aperture 108 and, upon cooling, solidify to hermetically fluid access aperture 108. In some examples, material 122 may fill substantially the entire length 116 of fluid access aperture 108. In other examples, material 122 may fill a lesser portion of length 116 of fluid access aperture 108. For instance, in some examples, material 122 may fill between approximately 25 percent of length 116 and approximately 75 percent of length 116 with material 122. Depending on the thickness of housing 100, in some examples, material 122 may fill between approximately 0.006 inches of length 116 and approximately 0.010 inches of length 116. Filling a lesser portion of length 116 of fluid access aperture 108 with material 122 may reduce processing time and the amount of material removed from the sidewall of housing 100.

While fluid access aperture 108 may be sealed with material 122 melted from a sidewall of housing 100, the process of sealing fluid access aperture 108 may cause electrolytic fluid to escape from electrolytic chamber 107 and onto an outer surface (e.g., first surface 110) of housing 100. When electrolytic fluid escapes out of electrolytic chamber 107, the fluid may interfere with the sealing material that used to fill fluid access aperture 108. For example, when laser 118 is used to melt a portion of housing 100 adjacent fluid access aperture 108, the laser energy from laser 118 may cause some electrolytic fluid to evaporate out of electrolyte chamber 107 and onto an outer surface (e.g., first surface 112) of housing 100. This electrolytic fluid may mix with the material that is melted from housing 100 to seal fluid access aperture 108, potentially increasing the porosity or otherwise degrading the integrity of the material used to seal fluid access aperture 108 as compared to when the material does not mix with electrolytic fluid outside of housing 100.

In accordance with some examples of the present disclosure, however, the amount of electrolytic fluid that is discharged from electrolytic chamber 107 through fluid access aperture 108 while sealing fluid access aperture 108 may be reduced or eliminated by controlling the dimensions of fluid access aperture 108. For example, with further reference to FIG. 3A, the dimensions of fluid access aperture 108 may be controlled such that length 116 of fluid access aperture 108 is greater than major width 114 of fluid access aperture 108. In instances where fluid access aperture 108 defines a length greater than a width, the possibility that electrolytic fluid may discharge out of electrolytic chamber 107 while fluid access aperture 108 is being sealed may be reduced or eliminated as compared to fluid access apertures with different types of configurations. While not wishing to be bound by any particular theory, it is believed that a fluid access aperture with a flow path length (i.e., length 116) that is greater than flow path width (i.e., major width 114) may reduce inadvertent fluid discharge by providing sufficient contact area (i.e., along length 114) for electrolytic fluid to contact as the electrolytic fluid begins to exit electrolytic chamber 107. This may cause the electrolytic fluid to condense within fluid access aperture 108 and to flow back into electrolytic chamber 107 without exiting housing 100.

In some examples in accordance with the present disclosure, fluid access aperture 108 may define a ratio of length 116 to major width 114 (i.e., length 116 divided by major width 114) greater than greater than approximately 2, such as, e.g., greater than approximately 10, or even greater than approximately 20. For example, fluid access aperture 108 may define a ratio of length 116 to major width 114 between approximately 2 and approximately 20, such as, e.g., between approximately 2.25 and approximately 8.33, or between approximately 3 and approximately 15, or between approximately 10 and approximately 20. Other ratios are both possible and contemplated.

Independent of the specific ratio of length 116 to major width 114 for fluid access aperture 108, fluid access aperture 108 may define any suitable absolute length 116 and width 114. For example, while major width 114 may vary, e.g., based on the size of electrolytic chamber 107, in some examples, major width 114 may be greater than approximately 0.001 inches, such as, e.g., greater than approximately 0.005 inches. In other examples, major width 114 may be less than a specific dimension such as, e.g., less than approximately 0.015 inches, or less than approximately 0.007 inches. In still other examples, major width 114 may range between approximately 0.003 inches and approximately 0.008 inches. Other dimensions are possible, however, and it should be appreciated that the disclosure is not limited in this respect.

In some examples, fluid access aperture 108 may define a length 116 that is greater than approximately 0.003 inches such as, e.g., greater than approximately 0.005 inches. In other examples, length 116 may be less than a specific value such as, e.g., less than approximately 0.035 inches, or less than approximately 0.015 inches. In still other examples, length 116 may range between approximately 0.006 inches and approximately 0.035 inches. Other dimensions for length 116 are both possible and contemplated, however, and the disclosure is not limited in this respect.

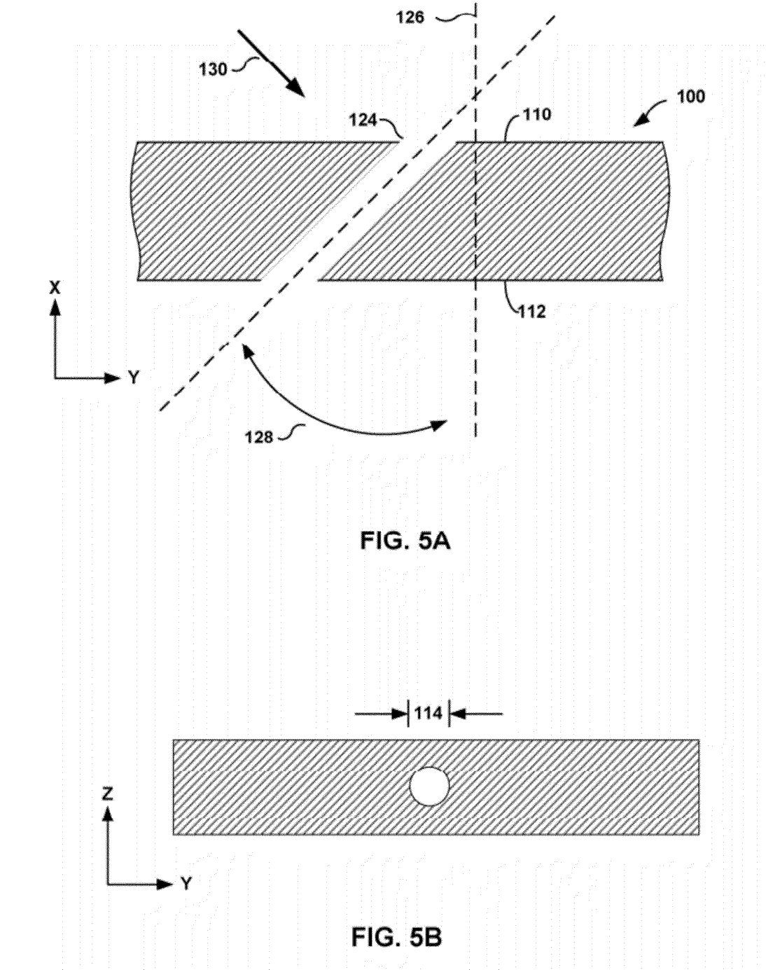

In addition to or in lieu of controlling the dimensions of fluid access aperture 108, the arrangement of fluid access aperture 108 on housing 100 may be controlled to enhance the electrolytic filling and/or sealing characteristics of capacitor 90. FIGS. 5A and 5B are different exploded schematic views of another example fluid filling aperture 124 that may be included on capacitor 90. As seen in FIGS. 5A and 5B, fluid access aperture 124 defines a substantially circular opening that extends from a first surface 110 to a second surface 112. First surface 110 may be an external surface of housing 100, while second surface 112 may be an internal surface of housing 100 that is in fluid contact with electrolytic fluid within electrolyte chamber 107. Fluid access aperture 124 may have a variety of different lengths (i.e., as measured along a centerline of fluid access aperture 124 from first surface 110 to second surface 112), widths, and cross-sectional shapes, as described above with respect to fluid access aperture 108.

In some examples, fluid access aperture 124 may arranged relative to housing 100 to reduce or eliminate electrolytic fluid discharge from electrolytic chamber 107 while sealing fluid access aperture 124. For example, as seen in FIG. 5A, fluid access aperture 124 may be angled relative to an axis 126 that is substantially orthogonal to a sidewall of housing 100. In some examples, such an arrangement of fluid access aperture 124 may reduce the possibility that electrolytic fluid may discharge out of electrolytic chamber 107 while fluid access aperture 124 is being sealed as compared to fluid access apertures with different types of configurations.

In general, fluid access aperture 124 may define any non-zero degree angle 128 between a centerline of fluid access aperture 124 and axis 126. For example, in some applications, fluid access aperture 124 may define an angle 128 between a centerline of fluid access aperture 124 and axis 126 that is less than approximately 90 degrees such as, e.g., less than approximately 45 degree. In some additional examples, fluid access aperture 124 may define an angle 128 between a centerline of fluid access aperture 124 and axis 126 that is more than 0 degrees such as, e.g., more than approximately 10 degrees. In still other examples, fluid access aperture 124 may define an angle 128 between a centerline of fluid access aperture 124 and axis 126 that ranges between approximately 5 degrees and approximately 75 degrees such as, e.g., between approximately 10 degrees and approximately 30 degrees. Other angles for fluid access aperture 124 are possible.

In instances where fluid access aperture 124 is angled relative to an axis that is substantially orthogonal to a sidewall of housing 100, the potential that electrolytic fluid may discharge out of electrolytic chamber 107 while fluid access aperture 124 is being sealed may be reduced or eliminated as compared to fluid access apertures with different types of configurations. While again not wishing to be bound by any particular theory, it is believed that a fluid access aperture that is angled relative to an axis that is substantially orthogonal to a sidewall of housing 100 may reduce inadvertent fluid discharge by providing contact area (i.e., in the X-direction indicated on FIG. 4A) for electrolytic fluid to contact as the electrolytic fluid begins to exit electrolytic chamber 107. This may cause the electrolytic fluid to collect on an interior surface of fluid access aperture 108 and to flow back into electrolytic chamber 107 without exiting housing 100.

Moreover, in some instances, such an example fluid access aperture may prevent laser energy from inadvertently entering electrolyte chamber 107 through fluid access aperture 124 while the fluid access aperture is being sealed with laser energy. As discussed above, a laser may be used to melt a portion of housing 100 adjacent a fluid access aperture such that melted material flows into the fluid access aperture to hermetically seal fluid access aperture. During this process, laser energy may be directed on an outside surface of housing 100 (e.g., first surface 110) in the region adjacent the fluid access aperture. The laser energy may melt a portion of housing 100 adjacent the fluid access aperture. However, if laser energy is inadvertently directed through the fluid access aperture, components of capacitor 90 may be damaged, rendering the capacitor unsuitable for subsequently use. For example, with reference to FIG. 2, if a laser beam enters housing 100 through fluid access aperture 108 while attempting to seal fluid access aperture 108, the laser beam may contact separator 106 and/or anode 104. In such a situation, separator 106 and/or anode 104 may absorb the energy from the laser beam, resulting in thermal damage to separator 106 and/or anode 104.

On the other hand, fluid access aperture 124 may prevent a laser beam from inadvertently entering electrolyte chamber 107 by providing an aperture that is angled relative to an axis that is substantially orthogonal to a sidewall of housing 100. By subsequently directing a laser beam on a portion of housing 100 adjacent fluid access aperture 124 such that the laser beam is not in parallel alignment with fluid access aperture 124, a portion of housing 100 adjacent fluid access aperture 124 may be melted without directing laser energy into electrolyte chamber 107. For example, a laser beam may be directed transverse to fluid access aperture 124 (e.g., as indicated by arrow 130) to melt a portion of housing 100 adjacent fluid access aperture 124. In these examples, a portion of housing 100 adjacent a fluid access aperture 124 may melt such that melted material flows into the fluid access aperture to hermetically seal fluid access aperture while minimizing laser interaction with the various components of capacitor 90.

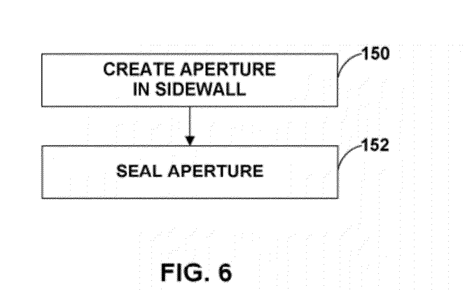

Different fluid access apertures have been described in relation to FIGS. 2-5. FIG. 6 is a flow diagram illustrating an example method that may be used fabricate an energy storage device that includes a fluid access aperture as described herein. The method includes creating an aperture in a sidewall of a housing of an energy storage device (150), and sealing the aperture with a sealing material (152). For ease of description, the method of FIG. 6 will be described with respect to capacitor 90 (FIGS. 2-5). In other examples, however, the method of FIG. 6 may be implemented with other types of energy storage devices or energy storage devices with configurations other than the configuration of capacitor 90.

As shown in FIG. 2, a fluid access aperture may be created in a sidewall of housing 100 of capacitor 90 (150). In some examples, the fluid access aperture may be created such that length 116 of the fluid access aperture is greater than major width 114 of fluid access aperture 108 (FIG. 3A). For example, the fluid access aperture may be created such that a ratio of length 116 to major width 114 is greater than approximately 2.25. In other examples, the fluid access aperture may be created such the fluid access aperture is angled relative to an axis 126 that is substantially orthogonal to a sidewall of housing 100 (FIG. 4A). For example, the fluid access aperture may be created such that an angle 128 between a centerline of fluid access aperture 124 and axis 126 that is substantially orthogonal to a sidewall of housing 100 is between approximately 10 degrees and approximately 30 degrees.

Different techniques can be used to create a fluid access aperture in a sidewall of housing 100 of capacitor 90 (150). In one example, the fluid access aperture may be cut or punched into a sidewall of housing 100. In another example, the fluid access aperture may be drilled in a sidewall of housing 100. For example, the fluid access aperture may be drilled with electrical discharge machining (EDM). In still other examples, the fluid access aperture may be created by directing a laser on a sidewall of housing 100. For example, a laser emitting optical pulses with a duration between approximately 0.1 nanoseconds and 10 picoseconds may be used to create the fluid access aperture.

The different components of capacitor 90 (e.g., cathode 102, anode 104, and separator 106) may be positioned within housing 100. Housing 100 may thereafter be sealed such that housing 100 is hermetically sealed except for fluid access aperture 108. Electrolytic fluid may then be added to electrolytic chamber 107 through the fluid access aperture 108.

With electrolytic chamber 107 suitably filled with electrolytic fluid, the fluid access aperture may be sealed with sealing material (152). In one example, a sealing material such as, e.g., solder, weld flux, a polymeric bonding agent, an epoxy, or the like may be introduced into the fluid access aperture so that the sealing material substantially blocks fluid communication through the aperture. In another example, laser 118 may direct laser beam 120 on a portion of housing 100 adjacent the fluid access aperture to melt a portion of housing 100 adjacent the fluid access aperture to a flowable state to fill the aperture (FIG. 4A). For example, laser 118 may emit optical pulses with a duration between approximately 0.1 milliseconds and 10 milliseconds on a portion of housing 100 adjacent the fluid access aperture to fill the fluid access aperture will melted material from housing 100. In any example, the fluid access aperture may be sealed with sealing material (152).

While in the preceding examples an energy source was described as a capacitor and a medical device was described as an implanted cardiac device, other applications of fluid access apertures in accordance with this disclosure may include alternate energy sources and/or medical devices. In general, the techniques of the disclosure may be applied to any type of enclosure that is filled with a fluid. In some examples, an energy source may be a battery or a capacitor with a configuration other than the configuration of the capacitor describe above. In some additional examples, a medical device may be a drug pump, a physiological parameter monitor, a spinal cord stimulator, a deep brain stimulators, or other implanted or external medical device. Furthermore, in still other examples, the techniques of the disclosure may be applied to an energy storage device that is not used with a medical device.

The following examples may provide additional details about a fluid access aperture in accordance with this disclosure.

### EXAMPLE 1

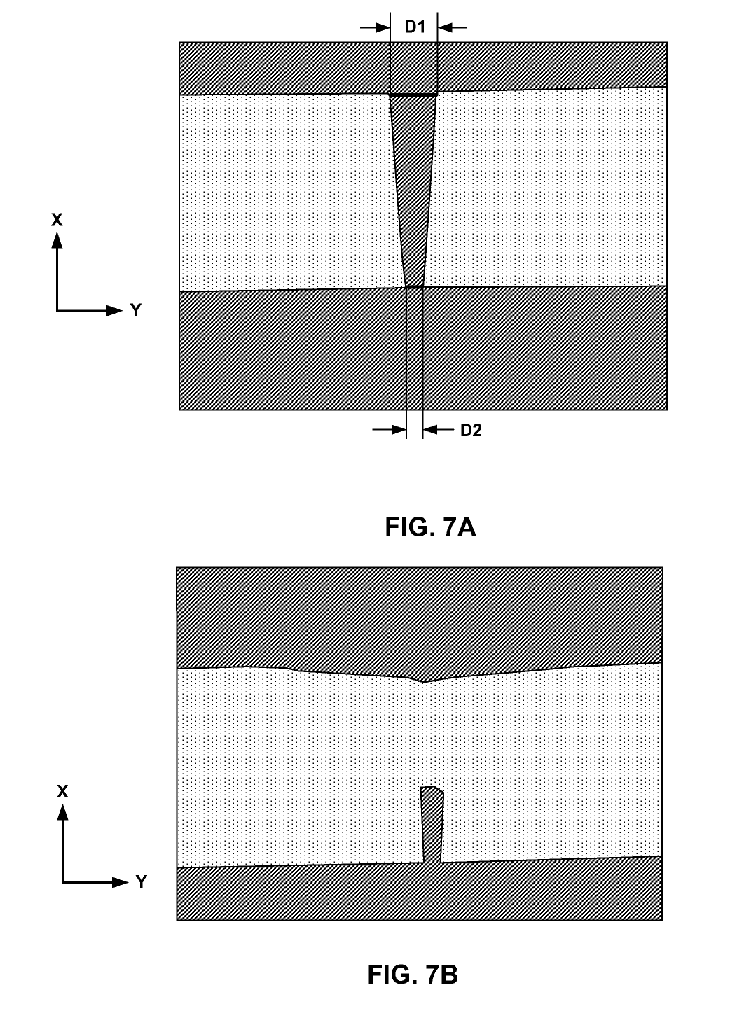

An example fluid access aperture was created in test substrate of 0.020 inch thick titanium. The fluid access aperture was created by directing a laser beam on the test substrate. The laser operated with a pulse width of 3.5 millisecond, a laser beam spot size of 0.016 inches, and a peak power of 600 Watts, at an argon gas flow rate of 85 standard cubic feet per hour. Four laser beam pulses were directed on the test substrate. This process resulted in a circular fluid access aperture that tapered from a diameter of 0.006 inches on the side of the test substrate adjacent the laser beam to a diameter of 0.004 inches on the side of the test substrate opposite the laser beam. FIG. 7A is a cross-sectional image of this example fluid access aperture.

After creating the fluid access aperture in the test substrate, the fluid access aperture was sealed by directing a laser beam from the laser described above on a portion of the test substrate adjacent the fluid access aperture. The laser operated with a pulse width of 3.5 millisecond, a laser beam spot size of 0.016 inches, and a peak power of 600 Watts, at an argon gas flow rate of 85 standard cubic feet per hour. Four laser beam pulses were directed on the test substrate adjacent the fluid access aperture. This process melted the test substrate adjacent the fluid access aperture such that the melted material filled the 0.020 inch long fluid access aperture with approximately 0.010 inches of material. FIG. 7B is a cross-sectional image of this example sealed fluid access aperture.

### EXAMPLE 2

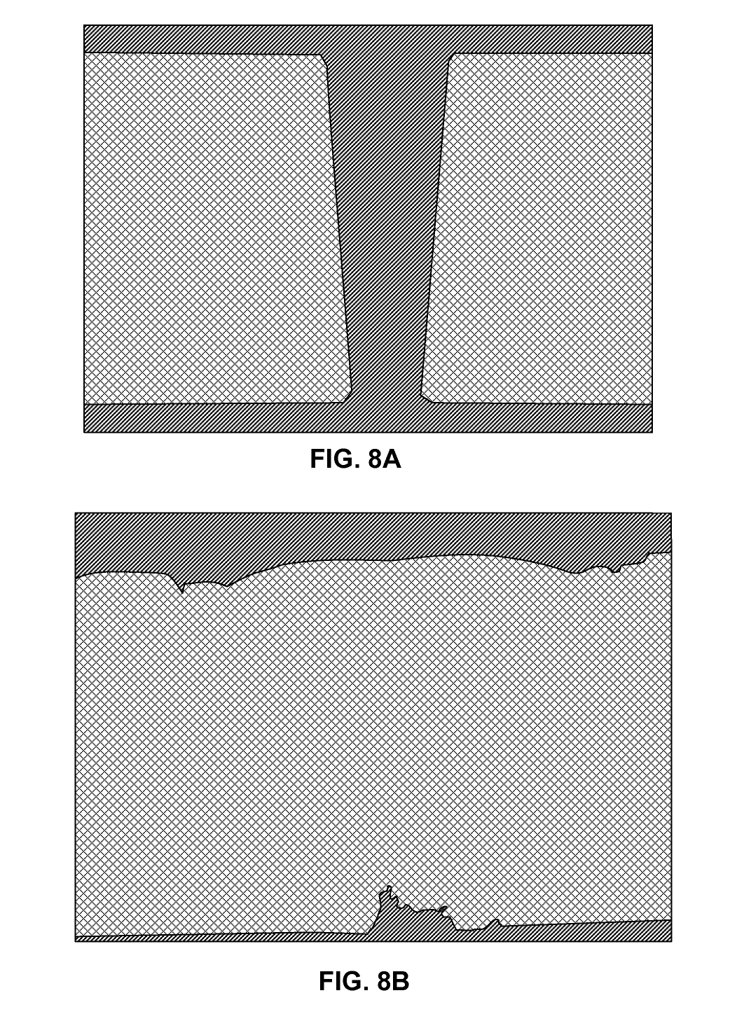

An example fluid access aperture was created in test substrate of 0.032 inch thick 304L stainless steal. The fluid access aperture was created by directing a laser beam on the test substrate. The laser operated with a pulse width of 5 millisecond, a laser beam spot size of 0.025 inches, and a peak power of 1000 Watts, at an argon gas flow rate of 125 standard cubic feet per hour. Four laser beam pulses were directed on the test substrate. This process resulted in a circular fluid access aperture that tapered from a diameter of 0.01 inches on the side of the test substrate adjacent the laser beam to a diameter of 0.06 inches on the side of the test substrate opposite the laser beam. FIG. 8A is a cross-sectional image of this example fluid access aperture.

After creating the fluid access aperture in the test substrate, the fluid access aperture was sealed by directing a laser beam from the laser described above on a portion of the test substrate adjacent the fluid access aperture. The laser operated with a pulse width of 5 millisecond, a laser beam spot size of 0.025 inches, and a peak power of 1000 Watts, at an argon gas flow rate of 125 standard cubic feet per hour. Four laser beam pulses were directed on the test substrate adjacent the fluid access aperture. This process melted the test substrate adjacent the fluid access aperture such that the melted material filled substantially the entire length of the 0.032 inch long fluid access aperture with material. FIG. 8B is a cross-sectional image of this example sealed fluid access aperture.

Various examples have been described. These and other examples are within the scope of the following claims.

1. An energy storage device comprising:
a housing that includes at least one sidewall, the housing defining a chamber for storing electrolytic fluid,
wherein the at least one sidewall defines an aperture formed through the at least one sidewall, the aperture defining a major width (W) that extends across a cross-sectional area of the aperture, and the aperture defining a length (L) that extends through the at least one sidewall, and
wherein the length of the aperture is greater than the major width of the aperture.

2. The energy storage device of claim 1, wherein the aperture defines a substantially circular cross-sectional shape, the major width (W) of the aperture is defined by a diameter of the substantially circular cross-sectional shape, and wherein the length (L) of the aperture is defined by a thickness of the at least one sidewall.

3. The energy storage device of claim 1, wherein a ratio of the length of the aperture to the major width of the aperture (L/W) is between approximately 2.25 and approximately 8.33.

4. The energy storage device of claim 3, wherein the major width (W) is between approximately 0.003 inches and approximately 0.008 inches.

5. The energy storage device of claim 3, wherein the length (L) is between approximately 0.006 inches and approximately 0.035 inches.

6. The energy storage device of claim 1, further comprising a sealing material disposed in the aperture such that the sealing material substantially blocks fluid communication through the aperture.

7. The energy storage device of claim 6, wherein the sealing material comprises material from the at least one sidewall that was melted to a flowable state to fill the aperture.

8. The energy storage device of claim 1, further comprising a cathode positioned in the chamber, an anode positioned in the chamber, and the electrolytic fluid in the chamber.

9. A method comprising:
creating an aperture in a sidewall of a housing that defines a chamber for storing electrolytic fluid,
wherein creating the aperture comprises creating the aperture such that a length of the aperture that extends through the sidewall is greater than a major width of the aperture that extends across a cross-sectional area of the aperture.

10. The method of claim 9, wherein creating the aperture comprises directing a laser on the sidewall.

11. The method of claim 9, wherein creating the aperture comprises creating the aperture such that the aperture defines a substantially circular cross-sectional shape, the major width of the aperture defined by a diameter of the substantially circular cross-sectional shape, and the length of the aperture is defined by a thickness of the sidewall.

12. The method of claim 9, wherein creating the aperture comprises creating the aperture such that a ratio of the length of the aperture to the major width of the aperture is between approximately 2.25 and approximately 8.33.

13. The method of claim 12, wherein the major width is between approximately 0.003 inches and approximately 0.008 inches.

14. The method of claim 12, wherein the length is between approximately 0.006 inches and approximately 0.035 inches.

15. The method of claim 9, further comprising sealing the aperture with a sealing material such that the sealing material substantially blocks fluid communication through the aperture.

16. The method of claim 15, wherein sealing the aperture comprises directing a laser on the sidewall adjacent the aperture to melt a portion of the sidewall to a flowable state to fill the aperture.

17. An energy storage device comprising:
a housing that includes at least one sidewall, the housing defining a chamber for storing electrolytic fluid,
wherein the at least one sidewall defines an aperture formed through the at least one sidewall, and
wherein the aperture is angled relative to an axis that is substantially orthogonal to the at least one sidewall.

18. The energy storage device of claim 17, wherein the angle between the aperture and the axis is between approximately 10 degrees and approximately 30 degrees.

19. The energy storage device of claim 18, wherein a major width that extends across a cross-sectional area of the aperture is between approximately 0.003 inches and approximately 0.008 inches.

20. The energy storage device of claim 17, further comprising a sealing material disposed in the aperture such that the sealing material substantially blocks fluid communication through the aperture.

21. The energy storage device of claim 20, wherein the sealing material comprises material from the sidewall that was melted to a flowable state to fill the aperture.

22. A method comprising:
creating an aperture in a sidewall of a housing that defines a chamber for storing electrolytic fluid,
wherein creating an aperture comprises creating the aperture such that the aperture is angled relative to an axis that is substantially orthogonal to the sidewall.

23. The method of claim 22, wherein creating the aperture comprising directing a laser on the sidewall.

24. The method of claim 22, wherein creating the aperture comprises creating the aperture such that the angle between the aperture and the axis is between approximately 10 degrees and approximately 30 degrees.

25. The method of claim 22, wherein a major width that extends across a cross-sectional area of the aperture is between approximately 0.003 inches and approximately 0.008 inches.

26. The method of claim 22, further comprising sealing the aperture with a sealing material such that the sealing material substantially blocks fluid communication through the aperture.

27. The method of claim 26, wherein sealing the aperture comprises directing a laser on the sidewall adjacent the aperture to melt a portion of the sidewall to a flowable state to fill the aperture.
